(19) United States
(12) Patent Application Publication
(10) Pub. No.: US 2026/0276093 A1
(43) Pub. Date: Sep. 17, 2026

(54) VALVE FOR PERSONAL HYDRATION DEVICE

(71) Applicant: Bryan S. CARGOULD, Burton, OH (US)

(72) Inventor: Bryan S. CARGOULD, Burton, OH (US)

(21) Appl. No.: 19/550,835

(22) Filed: Feb. 26, 2026

Related U.S. Application Data
(60) Provisional application No. 63/770,099, filed on Mar. 11, 2025.

(51) Int. Cl. F16K 11/06

(52) U.S. Cl. CPC F16K 11/06

(57) ABSTRACT

Provided herein is a three-way valve for a personal hydration system. The three-way valve is configured to allow selection of a first position where fluid flow is prevented in all directions, a second position to facilitate drinking from the personal hydration system, and a third position to facilitate filling or emptying of a reservoir of the personal hydration system. The three-way valve includes a body, a first barb coupled to the body, a second barb coupled to the body, a valve stem rotatably coupled within a cavity of the body, and a receptacle configured to attach to a threaded neck of a water bottle. The valve stem is rotated between the first, second, and third positions to regulate fluid flow for the personal hydration device.

### CROSS-REFERENCE TO RELATED APPLICATIONS

This application claims the benefit of U.S. Provisional Patent Application Ser. No. 63/770,099, filed on Mar. 11, 2025, entitled “VALVE FOR PERSONAL HYDRATION DEVICE”, which is incorporated herein by reference in its entirety.

### TECHNICAL FIELD

The present disclosure relates to personal hydration devices, and more particularly, fill valves for personal hydration devices.

### BACKGROUND

Personal hydration devices are widely used in outdoor, athletic, or military applications to provide users with a convenient way to access and drink fluids while engaged in physical activities. Traditional hydration solutions, such as water bottles can be difficult to access during physical activities like hiking, cycling, or running. To address these limitations, various wearable hydration devices have been developed, allowing for hands-free hydration.

While existing hydration devices have gained widespread adoption, they still present certain drawbacks associated with cleaning, maintenance, and/or filling of the fluid reservoirs. Accordingly, there is a need for improved hydration devices or accessories that enhance usability and user comfort while addressing the shortcomings of conventional designs.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Conventional hydration devices generally include a reservoir for holding liquid, a drinking tube that delivers liquid from the reservoir to a user, a bite valve, mouthpiece, or other flow control mechanism at the end of the tube to regulate fluid intake, and a refill cap located on the reservoir for refilling the reservoir. Often, the reservoir of the hydration devices is conveniently located within a backpack or other wearable device to facilitate hands-free transportation and drinking while performing various physical activities.

As discussed above, there are certain limitations or drawbacks to conventional wearable fluid hydration devices. These limitations are addressed in the present disclosure. For instance, in devices with fluid reservoirs, a user may be required to partially remove or disassemble the hydration device to refill the fluid reservoir. This is especially true when the reservoir is located within a backpack or other wearable device. In this example, the user may be required to remove the backpack, remove the fluid reservoir from the backpack, remove the cap, pour fluid into the reservoir, re-attach the cap, and then finally reseal the wearable device. This can be inconvenient, time-consuming, or even difficult depending on the user's physical activity or environment. The present disclosure provides a system and device in which a user may re-fill a reservoir of a wearable fluid hydration device without having to remove the wearable device, without having to remove the reservoir, and/or without having to remove the re-fill cap of the reservoir.

As disclosed herein, a re-fill valve is provided to facilitate the filling of a reservoir without having to remove the wearable device or the reservoir, and/or without having to remove the re-fill cap of the reservoir. In certain implementations, the re-fill valve may be installed in-line with tubing of a conventional wearable hydration system to facilitate filling the reservoir. The valve may be a three-way valve configurable between a filling position, a drinking position, and a closed position. In some implementations, the valve may comprise more or less than three positions.

In an embodiment, a three-way valve may be configured to regulate fluid flow for a personal hydration device. The three-way valve may include a body having a first opening, a second opening, a third opening, and a cavity within the body, a first barb fluidly coupled to the body at the first opening, a second barb fluidly coupled to the body at the second opening, and a receptacle fluidly coupled to the body at the third opening, the receptacle configured to removably couple the third opening to a threaded neck of a water bottle. The three-way valve may further include a valve stem rotatable within the cavity of the body where the valve stem is selectively rotated between a plurality of positions to regulate the fluid flow for the personal hydration device, such that the fluid flow is regulated to permit drinking from the personal hydration device and to permit filling of the personal hydration device through the receptacle.

The three-way valve may be configured to rotate between a first position in which fluid flow is prevented through the first barb, the second barb, and the receptacle, a second position in which fluid is permitted to flow between the first barb and the second barb to facilitate fluid flow from the fluid reservoir to the mouthpiece for drinking by a user, and a third position in which fluid is permitted to flow between the receptacle and the second barb to facilitate fluid flow from a water bottle coupled to the receptacle to the fluid reservoir to facilitate filling of the fluid reservoir from the water bottle or draining of the fluid reservoir.

Similarly, a personal hydration device can include a wearable carrying device comprising a fluid reservoir, a mouthpiece in fluid connection with the fluid reservoir, a length of tubing fluidly connecting the fluid reservoir to the mouthpiece, and the disclosed three-way valve installed in-line with the length of tubing.

The foregoing and other features will be described in greater detail with reference to the accompanying drawings.

### BRIEF DESCRIPTION OF THE DRAWINGS

FIG. 1 is a perspective view of a valve for a personal hydration device according to the disclosure provided herein.

FIG. 2 is another perspective view of the valve for a personal hydration device according to the disclosure provided herein.

FIG. 3 is another perspective view of the valve for a personal hydration device according to the disclosure provided herein.

FIG. 4 is another view of the valve for a personal hydration device according to the disclosure provided herein.

FIG. 5 is a cutaway view of the valve for a personal hydration device according to the disclosure provided herein.

FIG. 6 is an exemplary implementation of the valve utilized with a personal hydration device.

FIG. 7 is a close-up view of FIG. 6 showing the valve integrated into the tubing of a personal hydration device.

FIGS. 8A-8C are additional implementations of the valve for a personal hydration device according to the disclosure provided herein.

FIG. 9 is an exemplary implementation of a strap for the valve.

FIGS. 10A-10C are exemplary implementations of a valve stem according to the disclosure provided herein.

FIG. 11 is an exemplary implementation of a nut for the valve.

FIG. 12 is an exemplary implementation of a barb connector for the valve.

FIG. 13 is an exemplary implementation of a plug for the valve.

FIGS. 14A-14F are exemplary implementations of the valve assembly according to the disclosure provided herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

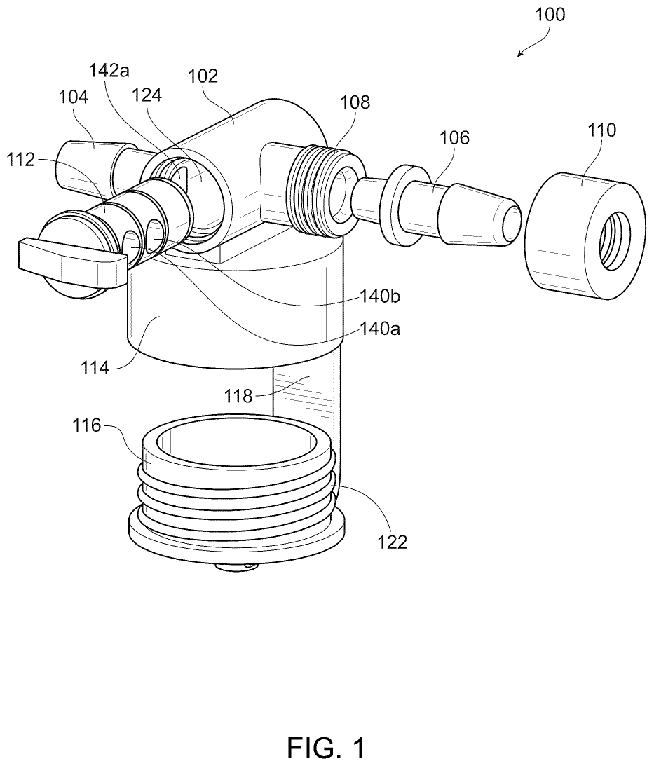

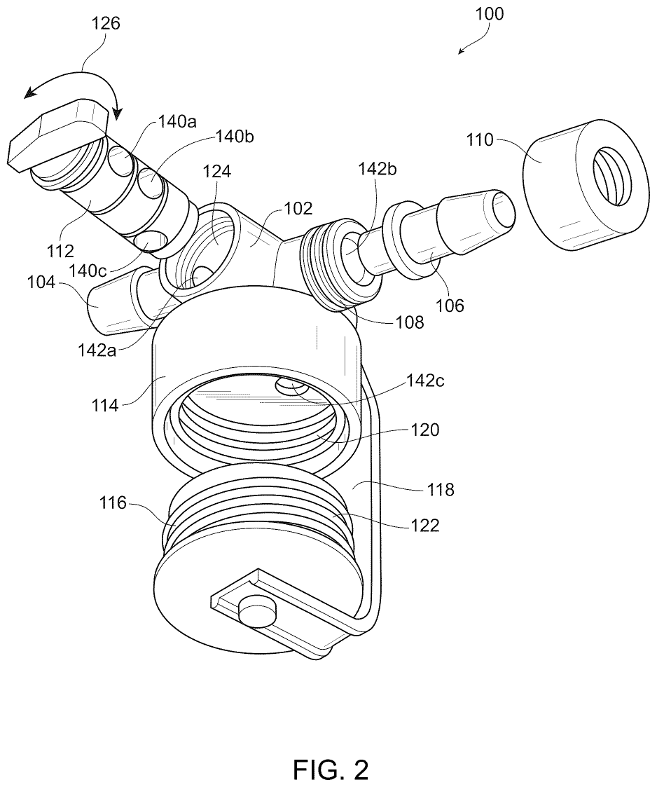

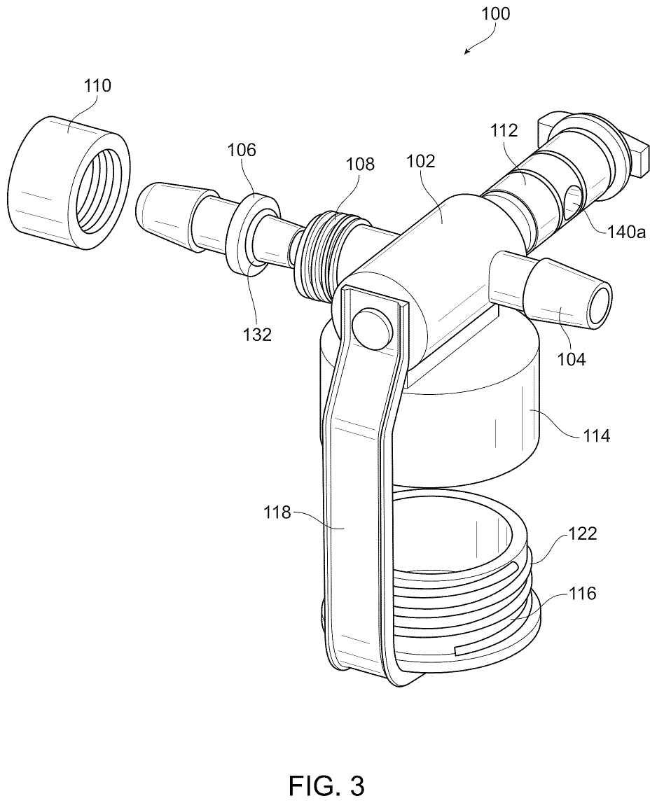

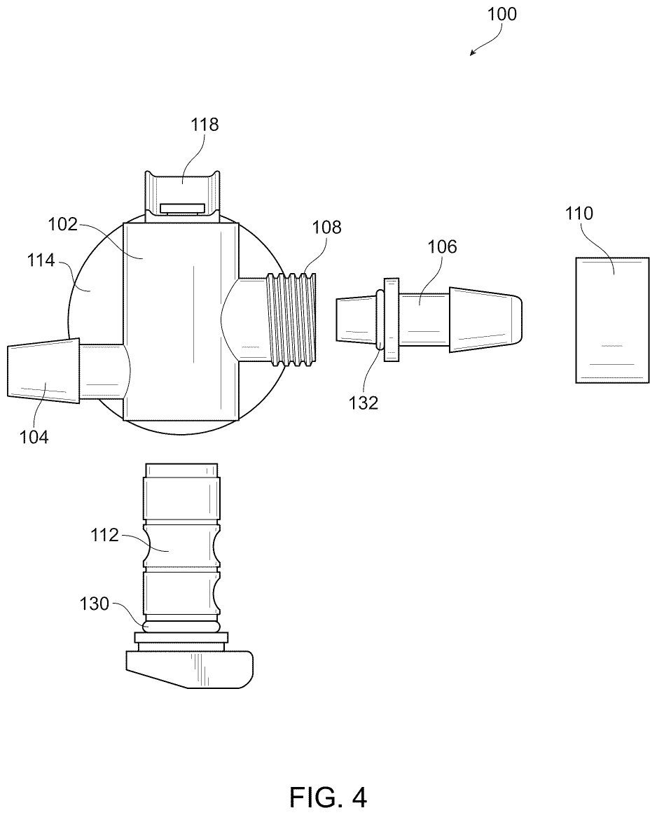

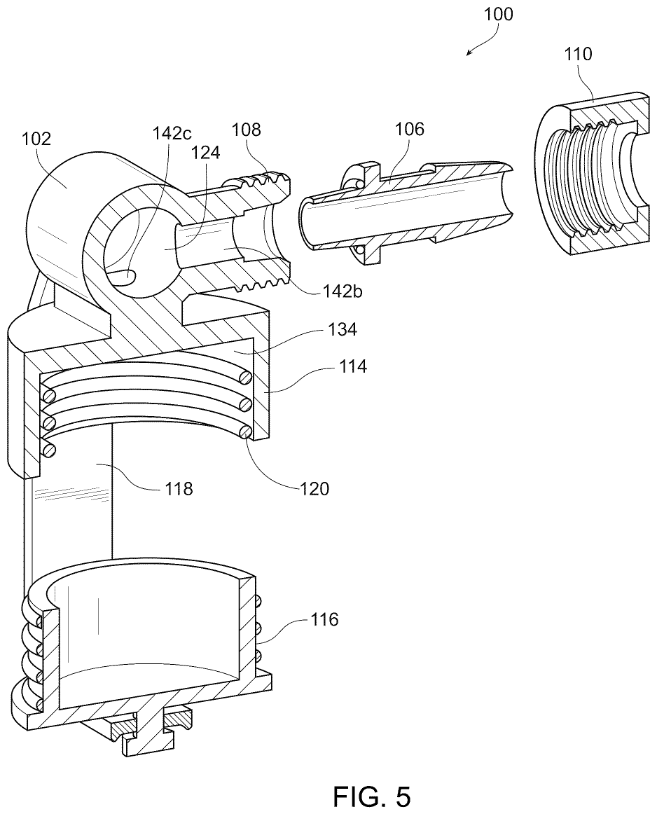

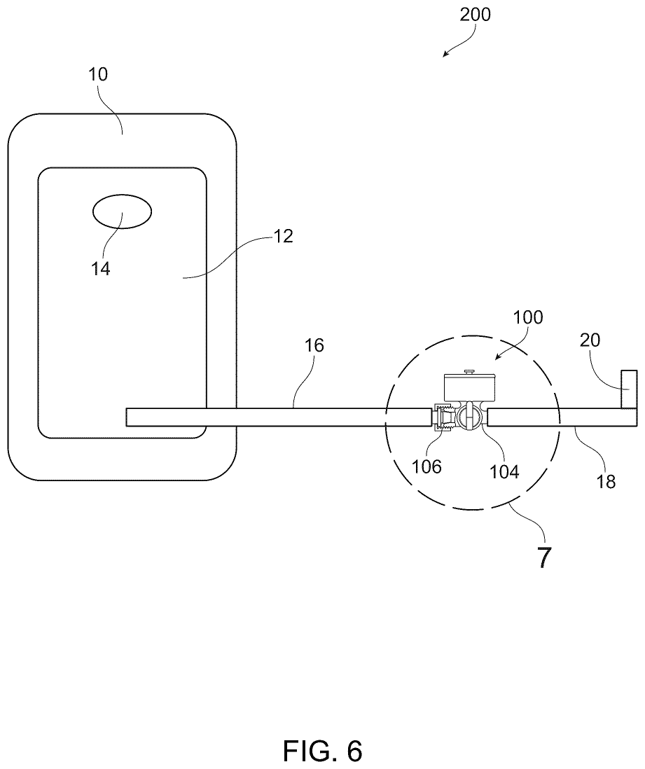

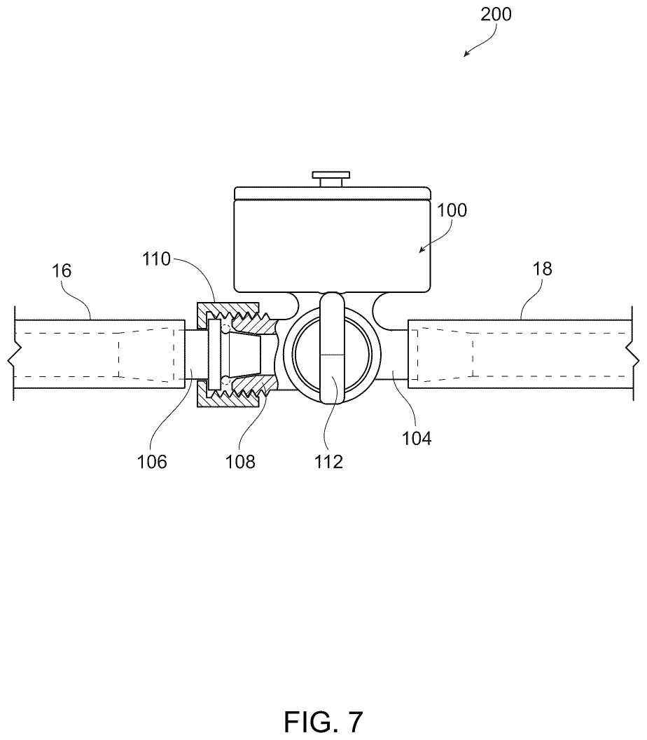

Turning to FIGS. 1-5, an exemplary implementation of a valve 100 is shown. The valve 100 may be a three-way valve configured for use with a personal hydration device 200 (shown at FIGS. 6-7). The valve may be configured for operation in a first OFF position in which fluid is not permitted to flow through the various fluid pathways of the valve 100, a second DRINKING position to permit fluid flow along a first pathway for drinking, and a third FILLING position to permit fluid flow along a second pathway for refilling purposes.

The valve 100 can include a valve body 102, a first barb 104, a second barb 106, a valve stem 112, a bottle receptacle 114, a cap 116 (or plug 116), and a strap 118. At least one of the barbs may be removably coupled to the body 102 using a threaded mechanism. As disclosed in the figures, the second barb 106 is removably attached to or coupled to the body 102 of the valve 100 using a nut 110 and corresponding threading 108. Although only the second barb 106 is illustrated as being removably coupled to the body 102, it should be appreciated that either or both of the first barb 104 and/or the second barb 106 may be removably attached to the body 102 in any suitable manner, including threading as shown in the figures. In other implementations, either or both of the first barb 104 or the second barb 106 may be removably coupled to the body 102 in any suitable manner such as with pressure fit, set screws, or any series of fluid coupling mechanisms or methods.

Those who use personal hydration devices will appreciate the many benefits of having at least one of the barbs easily removable from the valve body 102. For instance, tubing is often routed through a small opening in a backpack 10 from the reservoir 12 out to a mouthpiece 20 for drinking. Without a process for easy disconnection, removal and installation of the valve 100 to a conventional drinking device may be very difficult. Being able to disconnect the valve 100 from fluid tubing allows for easy installation, removal, and cleaning of the device 200. Said differently, the mouthpiece 20 and the valve 100 may not easily fit through the opening of the wearable device. To solve this problem, at least the first barb 104 or the second barb 106 may be removably coupled to the valve body 102 to facilitate easy removal and cleaning of the various components.

The receptacle 114 (sometimes referred to as a fill port 114) may include threading 120 located on an interior surface of the receptacle 114. The threading 120 may be configured to engage with a threading of a conventional disposable water bottle. For instance, the threading 120 may be a commonly used 28 mm PCO 1881 bottle thread that is used in most water bottles on the market, although any suitable threading or attachment means can be used. As will be disclosed below in more detail, a water bottle can be fluidly attached to the valve 100 through the receptacle 114 via the threading 120 to facilitate fluid transfer from the water bottle through the valve 100. While not in use, the plug 116 can be secured to the receptacle 114 via the threading 120. In an embodiment, the plug 116 also has corresponding threading 122 on the outer surface of the plug 116 to engage with the threading 120. However, it should be appreciated that the plug 116 can be attached to the receptacle 114 via any suitable manner such as pressure fit, snap fit, etc. The strap 118 can be used to attach the plug 116 to the body 102 when not attached to the receptacle 114 (e.g., while a water bottle is attached).

The valve stem 112 may be installed within a cavity 124 of the body 102. The cavity 124 may be in fluid connection with the first barb 104, the second barb 106, and the receptacle 114. Various openings in the valve stem 112 may engage with various openings within the body 102 to facilitate fluid flow within the valve 100 between the various connection points (e.g., receptacle 114, first barb 104, second barb 106). Fluid flow may change depending on the rotational position and/or lateral position of the valve stem 112 within the cavity 124. That is, the valve stem 112 may rotate in a direction denoted by the arrow 126 between multiple positions. As illustrated, the valve stem 112 may rotate between three positions having different fluid flow characteristics. Specifically, the openings 140a, 140b, and 140c of the valve stem 112 may engage with various openings 142a, 142b, and 142c of the valve body 102 depending on the position of the valve stem 112 with respect to the valve body 102. Rotating the valve stem 112 may dictate fluid flow characteristics through the hollow valve stem 112 by aligning and/or closing off fluid flow paths.

The cavity 124 of the body 102 may be a generally cylindrical bore extending through at least a portion of the body 102 and configured to receive the valve stem 112 therein. The cavity 124 may be sized to closely receive the valve stem 112 such that the valve stem 112 can rotate within the cavity 124 while maintaining a substantially fluid-tight interface between the outer surface of the valve stem 112 and the inner surface of the cavity 124. In some implementations, the inner surface of the cavity 124 may include one or more grooves or recesses configured to receive one or more O-rings, such as O-ring 130, to create a seal between the valve stem 112 and the body 102. The cavity 124 may further include one or more detent features, such as grooves, notches, or raised portions, configured to provide tactile feedback or resistance as the valve stem 112 is rotated between positions, thereby assisting a user in identifying and maintaining the selected valve position (e.g., OFF, DRINKING, or FILLING). In other examples, the cavity 124 may refer to the complete inner cavity volume within the body 102.

In an embodiment, the first barb 104 may be fluidly coupled to the body 102 via the first opening 142a, the second barb 106 may be fluidly coupled to the body 102 via the second opening 142b, and the receptacle 114 may be fluidly coupled to the body 102 via the third opening 142c. In this manner, each of the first opening 142a, the second opening 142b, and the third opening 142c may provide fluid flow from each of the first barb 104, the second barb 106, and the receptacle 114 to the cavity 124 of the valve 100.

In the first position, the valve 100 (through the valve stem 112) may prevent fluid flow between all of the receptacle 114, the first barb 104, and the second barb 106 by closing off fluid flow between all of the first opening 142a, the second opening 142b, and the third opening 142c. Therefore, the first position may be referred to as an OFF position in which fluid is not permitted to flow between the various openings. The OFF position may be dictated by the rotational position of the valve stem 112 such that neither of the valve stem openings 140a, 140b, or 140c align with and provide a fluid flow path with the opening 142a, 142b, or 142c.

In the second position, fluid may be permitted to flow between the first barb 104 via the first opening 142a and the second barb 106 via the second opening 142b, but not the receptacle 114 via the third opening 142c. This may be referred to as a DRINKING position. In this position, fluid may flow freely between the first barb 104 and the second barb 106 (and the valve stem 112) so that fluid can flow from the reservoir 12 to a mouthpiece 20 for drinking. The DRINKING position may be dictated by the rotational position of the valve stem 112 such that the valve stem openings 140a, 140b, or 140c align with and provide a fluid flow path between the first opening 142a and the second opening 142b.

In the third position, fluid may be permitted to flow between the second barb 106 via the second opening 142b and the receptacle 114 via the third opening 142c, but not the first barb 104 via the first opening 142a. This may be referred to as a FILLING position. In this position, fluid may flow from a water bottle connected to the receptacle 114 to the reservoir 12 of a personal hydration device. The third position may also be referred to as an EMPTYING position because fluid may also be drained from the reservoir 12 while the valve 100 is in the third position.

It should be appreciated, however, that other various positions or valve configurations may be utilized. For instance, in the example given herein, the first barb 104 is connected proximate the drinking mouthpiece 20, and the second barb 106 is proximate the reservoir 12 of a personal hydration device. But, in certain examples, this connection scheme may be reversed, and in which case, the DRINKING and FILLING positions would be opposite.

The chart below illustrates various exemplary positions/configurations of the valve 100. In this example, the valve 100 is a three-way valve.

| Valve Position | Receptacle 114 | First Barb 104 | Second Barb 106 |
|---|---|---|---|
| 1 - OFF | NO FLOW | NO FLOW | NO FLOW |
| 2 - DRINKING | NO FLOW | FLOW | FLOW |
| 3 - FILLING/ | FLOW | NO FLOW | FLOW |
| EMPTYING | | | |

Although the valve 100 is disclosed as a three-way valve, the valve 100 can have any number of configurations, and may be configured as a two-way valve or a four-way valve without deviating from the scope of the disclosure. Moreover, the valve 100 may be a simple ON/OFF valve or the valve 100 may utilize a mechanism to regulate flow rate for drinking or filling purposes. Yet in other examples, the valve 100 may include flow restrictors or check valves to prevent flow in certain directions. For instance, a check valve could be used near the receptacle 114 to allow flow of fluid from a water bottle to a fluid reservoir 12 of a personal device but not allow flow back out of the fluid reservoir 12.

Various O-rings or gaskets may be used with the valve 100 to prevent leakage. For example, the O-ring 130 can be utilized to create a seal between the valve stem 112 and the body 102. The O-ring 132 can be utilized to create a seal between the second barb 106 and the body 102. The gasket 134 may be used to create a seal between a rim of a water bottle and an interior surface of the receptacle 114. Other O-rings and/or gaskets may be used according to various sealing or fluid requirements.

In other embodiments, the valve 100 may incorporate various sensors or filtration mechanisms to enhance the quality and safety of the fluid before it enters the fluid reservoir 12. These sensors may include water quality sensors capable of detecting contaminants, such as bacteria, heavy metals, or chemical impurities, ensuring that only safe and potable water is stored. Additionally, the valve 100 may integrate flow sensors to monitor the rate of fluid passage, pressure sensors to regulate optimal hydration flow, or temperature sensors to provide real-time data on water temperature. Furthermore, filtration components may include activated carbon filters for removing chlorine and organic compounds, membrane filters for trapping microscopic particles, or advanced purification elements such as UV sterilization modules to neutralize harmful pathogens. The integration of such sensors and filters enhances the reliability and usability of the hydration system, making it suitable for various environments, including outdoor activities, emergency situations, and military applications.

The valve 100 and its various components can be manufactured from materials that meet food-grade or drinking-grade safety standards to ensure safe and reliable use in personal hydration systems. Suitable materials may include injection-molded plastics, such as polyethylene, polypropylene, or polycarbonate, as well as other high-performance polymers known for their durability, chemical resistance, and compliance with food safety regulations. In some embodiments, certain components of the valve may be constructed from metals, such as stainless steel or aluminum, to enhance structural integrity and longevity. The selection of materials may vary depending on factors such as manufacturing feasibility, environmental conditions, and user preferences.

Turning to FIGS. 6-7, a personal hydration device 200 (sometimes referred to as personal hydration system 200) is shown. The personal hydration system 200 can include a wearable device 10 and a fluid reservoir 12 installed within the wearable device 10. In some examples, the wearable device 10 is a backpack. The fluid reservoir 12 includes a fill cap 14 for filling or emptying of the fluid reservoir 12. A first portion of tubing 16 may attach to the fluid reservoir 12 to provide fluid flow from the fluid reservoir 12 to a mouthpiece 20 for drinking from the fluid reservoir 12. As discussed, this configuration may represent conventional wearable hydration systems utilizing only a single portion of tubing to bring flow of liquid from the reservoir to the mouthpiece.

The system 200 can further include the new three-way valve 100 as disclosed herein to facilitate improved filling, emptying, and cleaning of the hydration system 200 without having to remove the fluid reservoir 12 from the wearable device 10. The valve 100 may be installed within the fluid tubing between the first portion of tubing 16 and the second portion of tubing 18 (e.g., in line with the tubing). The first barb 104 is attached to the second portion of tubing 18 towards the mouthpiece 20, and the second barb 106 is attached to the first portion of tubing 16 towards the fluid reservoir 12. By attaching the valve 100 in this manner, the first portion of tubing 16 can be easily removed and/or attached to the valve 100 to facilitate attachment and removal of the components from the wearable device 10. This can be beneficial because the fluid tubing is often directed through a small opening in the wearable device 10. Therefore, without a process to easily remove the tubing from the valve 100, a user would need to disconnect the tubing from the barb 106 itself, which can be challenging. It can also cause unwanted wear on the tubing itself.

By way of example, a user may transform a typical wearable hydration system into an improved hydration system 200 by adding the valve 100. To facilitate this, the user can locate a position on the existing tubing to install the valve 100. The user can cut the tubing at the desired position to form a first portion of tubing 16 and the second portion of tubing 18. The first portion of tubing 16 can be attached to the second barb 106, and the second portion of tubing 18 can be attached to the first barb 104. Attachment to the barbs may include sliding the tubing over the barbs, which may be held in place via pressure exerted on the barbs themselves. As discussed above, however, the portions of tubing may be attached to either of the barbs without deviation from the scope of the disclosure.

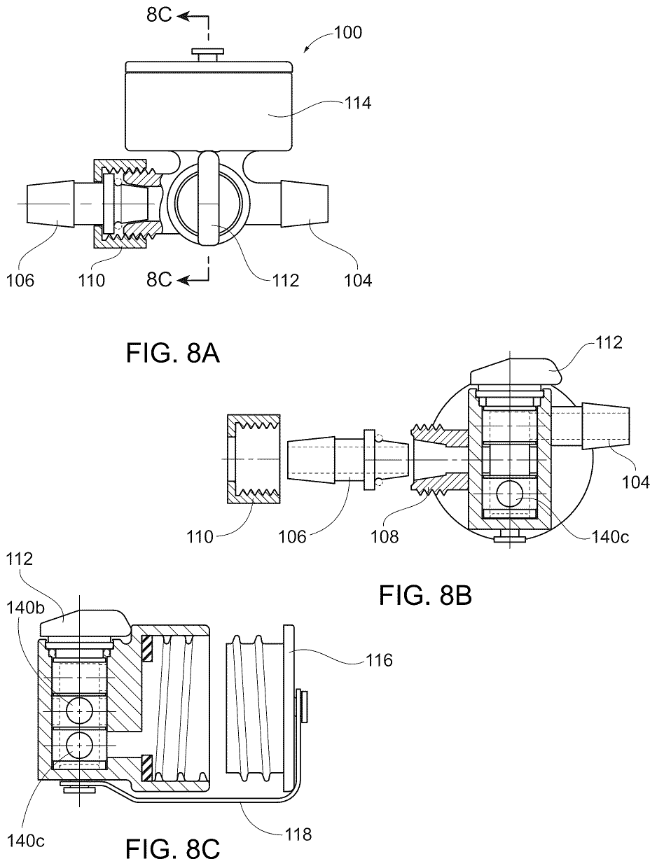

FIGS. 8-13 illustrate additional embodiments of the valve 100 and its various components. Specifically, FIGS. 8A-8C illustrate additional embodiments of the valve 100. FIG. 8A illustrates an embodiment of the valve 100 showing the receptacle 114, the first barb 104, the second barb 106, the nut 110, and the valve stem 112. FIG. 8B illustrates another view of the valve 100 showing the valve stem 112, the first barb 104, the nut 110, the second barb 106, and the threading 108. FIG. 8C illustrates an embodiment of the valve 100 with the plug 116 removed from the receptacle, showing the valve stem 112 having openings 140a, 140b, and 140c, and the strap 118. The embodiments illustrated in FIGS. 8A-8C may include different configurations of the body 102, different relative positions of the first barb 104, the second barb 106, and the receptacle 114, and/or different external geometries to accommodate various installation requirements for different wearable devices or hydration systems. The disclosure provided above with respect to FIGS. 1-7 may be equally applicable to the embodiments illustrated in FIGS. 8A-8C.

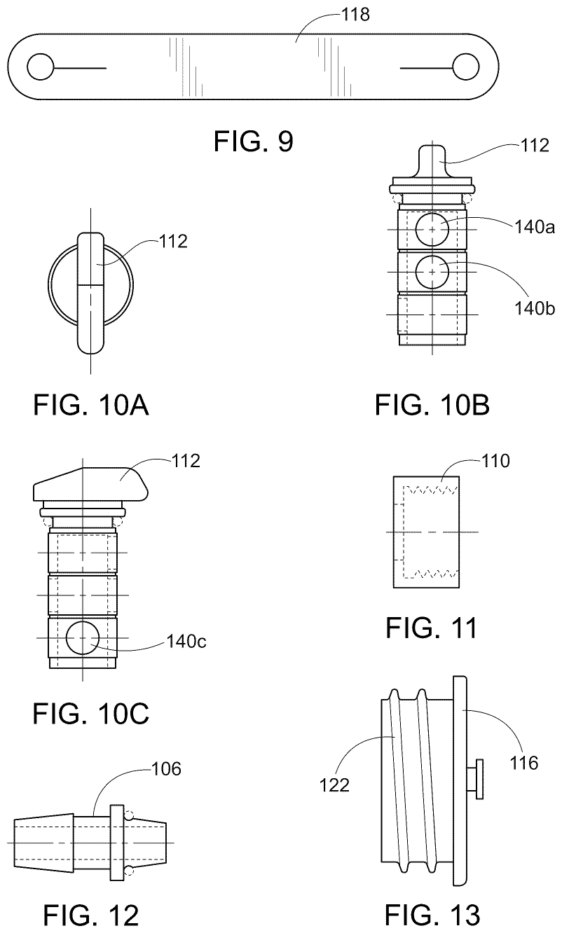

FIG. 9 illustrates an exemplary implementation of the strap 118. The strap 118 may be a flexible band, cord, or tether configured to connect the plug 116 to the body 102 of the valve 100. The strap 118 may be permanently or semi-permanently attached to the body 102 at a first end and to the plug 116 at a second end. In some implementations, the strap 118 may be integrally formed with the body 102 or the plug 116 during the manufacturing process. In other implementations, the strap 118 may be a separate component that is attached via a loop, clip, or adhesive. The strap 118 is configured to be of sufficient length to allow the plug 116 to hang freely from the body 102 when not engaged with the receptacle 114, such as when a water bottle is attached to the receptacle 114 during filling operations.

As shown in FIGS. 10A-10C, the valve stem 112 may be generally cylindrical in shape and configured to be received within the cavity 124 of the body 102. The valve stem 112 may include a plurality of openings, including a first valve stem opening 140a, a second valve stem opening 140b, and a third valve stem opening 140c connected internally by the hollow body of the valve stem 112. The size, shape, and positioning of the openings 140a, 140b, and 140c may be configured to selectively align with one or more of the first opening 142a, the second opening 142b, and the third opening 142c of the body 102 as the valve stem 112 is rotated. FIGS. 10A-10C illustrate an exemplary configuration of the valve stem 112. In some instances, the valve stem 112 may be configured in different configurations, each having different arrangements of the openings 140a, 140b, and 140c to achieve the desired fluid flow characteristics in each of the plurality of positions. The valve stem 112 may further include a gripping feature or indicator on an external-facing surface to facilitate manual rotation by a user and to provide a visual or tactile indication of the current valve position.

Turning to FIG. 11, an exemplary implementation of the nut 110 is shown. The nut 110 may be configured to threadingly engage with the threading 108 on the body 102 to secure the second barb 106 to the body 102. The nut 110 may include an internal bore sized to receive the second barb 106 or a portion thereof, and may include external surfaces configured for manual gripping by a user to facilitate hand-tightening and loosening of the nut 110. In some embodiments, the nut 110 may include knurling, ribs, or other textured features on its external surface to improve grip. The nut 110 may be manufactured from the same food-grade materials as the body 102, or from a different material, such as a metal, to provide enhanced durability at the threaded connection.

FIG. 12 illustrates exemplary implementations of barb connectors. A barb connector, such as the first barb 104 or the second barb 106, may include a series of ridges or barbed protrusions configured to engage with an inner surface of the tubing (e.g., the first portion of tubing 16 or the second portion of tubing 18) to create a friction fit that resists disconnection during normal use. The barbed protrusions may be angled or tapered in a direction that facilitates insertion of the barb into the tubing while resisting withdrawal. The barb connector (e.g., second barb 106) may further include a smooth cylindrical portion at a proximal end configured to be received within the body 102 or the nut 110, and the barbed portion at a distal end configured to engage with the tubing.

FIG. 13 illustrates an exemplary implementation of the plug 116, sometimes referred to as a cap 116. As discussed above, the plug 116 may include threading 122 on an outer surface thereof, the threading 122 configured to engage with the threading 120 on the interior surface of the receptacle 114 to create a fluid-tight seal when the plug 116 is installed in the receptacle 114. The plug 116 may further include a gripping surface, such as a knurled edge, flange, or tab, to facilitate manual installation and removal by a user. In some implementations, the plug 116 may include an O-ring or gasket on the plug 116 to enhance the seal between the plug 116 and the receptacle 114. The plug 116 may be connected to the strap 118 at a connection point, such as a loop, hole, or clip, to prevent loss of the plug 116 when removed from the receptacle 114 during filling operations.

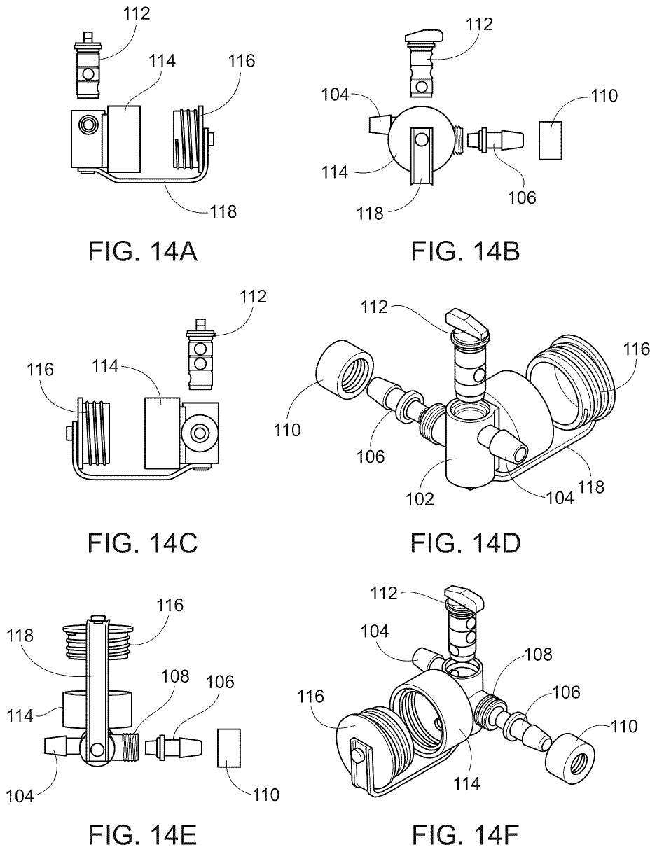

FIGS. 14A-14F illustrate exemplary implementations of the valve 100 in various stages of assembly and from various perspectives. These figures illustrate the valve 100 with the valve stem 112 and the receptacle 114 visible, and the plug 116 removed, with the strap 118 hanging freely from the body. The various views provided in FIGS. 14A-14F illustrate the relative arrangement and orientation of the components of the valve 100 and may assist in understanding the assembly and disassembly of the valve 100 for installation, cleaning, and maintenance purposes.

Although certain embodiments have been shown and described, it is understood that equivalents and modifications falling within the scope of the appended claims will occur to others who are skilled in the art upon the reading and understanding of this specification.

What is claimed is:

1. A three-way valve configured to regulate fluid flow for a personal hydration device, the three-way valve comprising:
a body comprising a first opening, a second opening, a third opening, and a cavity within the body;
a first barb fluidly coupled to the body at the first opening;
a second barb fluidly coupled to the body at the second opening;
a receptacle fluidly coupled to the body at the third opening, the receptacle configured to removably couple the third opening to a threaded neck of a water bottle; and
a valve stem rotatable within the cavity of the body, wherein the valve stem is selectively rotated between a plurality of positions to regulate the fluid flow for the personal hydration device, such that the fluid flow is regulated to permit drinking from the personal hydration device and to permit filling of the personal hydration device through the receptacle.

2. The three-way valve according to claim 1, wherein the first barb is in fluid connection with a mouthpiece of the personal hydration device and the second barb is in fluid connection with a fluid reservoir of the personal hydration device.

3. The three-way valve according to claim 2, wherein a first portion of tubing fluidly connects the first barb to the mouthpiece and a second portion of tubing fluidly connects the second barb to the fluid reservoir such that the three-way valve is fluidly coupled between the first portion of tubing and the second portion of tubing.

4. The three-way valve according to claim 2, wherein the valve stem is configured to rotate between:
a first position in which fluid flow is prevented through the first barb, the second barb, and the receptacle;
a second position in which fluid is permitted to flow between the first barb and the second barb to facilitate fluid flow from the fluid reservoir to the mouthpiece for drinking by a user; and
a third position in which fluid is permitted to flow between the receptacle and the second barb to facilitate fluid flow from a water bottle coupled to the receptacle to the fluid reservoir to facilitate filling of the fluid reservoir from the water bottle.

5. The three-way valve of claim 4, wherein in the second position, fluid is prevented from flowing through the receptacle and the third opening to prevent fluid flow to or from the receptacle.

6. The three-way valve of claim 4, wherein in the third position, fluid is prevented from flowing through the first barb and the first opening to prevent fluid flow to or from the mouthpiece.

7. The three-way valve according to claim 1, wherein the three-way valve is manufactured from a food grade injection molded plastic.

8. The three-way valve according to claim 1, wherein at least one of the first barb or the second barb is removably attached to the body of the three-way valve to facilitate installation and removal of a fluid reservoir from the personal hydration device.

9. The three-way valve according to claim 1, further comprising at least one sealing element disposed between the valve stem and the body to prevent fluid leakage, wherein the at least one sealing element comprises an O-ring configured to create a seal between the valve stem and the cavity of the body.

10. The three-way valve according to claim 1, further comprising a plug configured to removably engage with the receptacle to seal the third opening when a water bottle is not coupled to the receptacle, and a strap connecting the plug to the body of the three-way valve.

11. The three-way valve according to claim 4, wherein in the third position, fluid is also permitted to flow from the fluid reservoir through the second barb and the receptacle to facilitate draining or emptying of the fluid reservoir through a water bottle or open receptacle.

12. The three-way valve according to claim 1, wherein the valve stem comprises a plurality of openings configured to selectively align with one or more of the first opening, the second opening, or the third opening of the body as the valve stem is rotated between the plurality of positions to define fluid flow paths through the three-way valve.

13. A personal hydration device, comprising:
a wearable carrying device comprising a fluid reservoir;
a mouthpiece in fluid connection with the fluid reservoir;
a length of tubing fluidly connecting the fluid reservoir to the mouthpiece; and
a three-way valve installed in-line with the length of tubing, the three-way valve configured to facilitate fluid flow through the three-way valve to selectively permit fluid flow for drinking from the mouthpiece or to permit fluid flow for filling of the fluid reservoir through the three-way valve.

14. The personal hydration device according to claim 13, wherein the three-way valve comprises:
a body comprising a first opening, a second opening, a third opening, and a cavity within the body;
a first barb fluidly coupled to the body at the first opening;
a second barb fluidly coupled to the body at the second opening;
a receptacle fluidly coupled to the body at the third opening, the receptacle configured to removably couple the third opening to a threaded neck of a water bottle; and
a valve stem rotatable within the cavity of the body, wherein the valve stem is selectively rotated between a plurality of positions to regulate the fluid flow for the personal hydration device.

15. The personal hydration device according to claim 14, wherein the first barb is in fluid connection with the mouthpiece of the personal hydration device and the second barb is in fluid connection with the fluid reservoir of the personal hydration device.

16. The personal hydration device according to claim 15, wherein a first portion of tubing fluidly connects the first barb to the mouthpiece and a second portion of tubing fluidly connects the second barb to the fluid reservoir such that the three-way valve is fluidly coupled between the first portion of tubing and the second portion of tubing.

17. The personal hydration device according to claim 16, wherein the valve stem is configured to rotate between:
a first position in which fluid flow is prevented through the first barb, the second barb, and the receptacle;
a second position in which fluid is permitted to flow between the first barb and the second barb to facilitate fluid flow from the fluid reservoir to the mouthpiece for drinking by a user; and
a third position in which fluid is permitted to flow between the receptacle and the second barb to facilitate fluid flow from a water bottle coupled to the receptacle to the fluid reservoir to facilitate filling of the fluid reservoir from the water bottle.

18. The personal hydration device of claim 17, wherein in the second position, fluid is prevented from flowing through the receptacle and the third opening to prevent fluid flow to or from the receptacle, and in the third position, fluid is prevented from flowing through the first barb and the first opening to prevent fluid flow to or from the mouthpiece.

19. A three-way valve configured to regulate fluid flow for a personal hydration device, the three-way valve comprising:
a body comprising a first opening, a second opening, a third opening, and a cavity within the body;
a first barb fluidly coupled to the body at the first opening;
a second barb fluidly coupled to the body at the second opening;
a receptacle fluidly coupled to the body at the third opening, the receptacle configured to removably couple the third opening to a threaded neck of a water bottle;
a valve stem rotatable within the cavity of the body, wherein the valve stem is selectively rotated between a plurality of positions for regulating the fluid flow for the personal hydration device, wherein the plurality of positions comprise:
a first position in which fluid flow is prevented through the first barb, the second barb, and the receptacle;
a second position in which fluid is permitted to flow between the first barb and the second barb to facilitate fluid flow from a fluid reservoir of the personal hydration device to a mouthpiece for drinking by a user; and
a third position in which fluid is permitted to flow between the receptacle and the second barb to facilitate fluid flow from a water bottle coupled to the receptacle to the fluid reservoir to facilitate filling of the fluid reservoir from the water bottle.

20. The three-way valve according to claim 19, wherein in the second position, fluid is prevented from flowing through the receptacle and the third opening to prevent fluid flow to or from the receptacle, and in the third position, fluid is prevented from flowing through the first barb and the first opening to prevent fluid flow to or from the mouthpiece.
